(19) United States
(12) Patent Application Publication
(10) Pub. No.: US 2026/0135082 A1
(43) Pub. Date: May 14, 2026

(54) Graphene/Alkali Metal Composite Anode, Alkali Metal Battery, and Production Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/948,367

(22) Filed: Nov. 14, 2024

(51) Int. Cl. H01M 4/134; C01B 32/184; C01B 32/194; C01B 32/198; C01B 32/225; C01B 32/23; H01M 4/02; H01M 4/04; H01M 4/1395; H01M 4/62; H01M 10/0525; H01M 10/054; H01M 10/42

(52) U.S. Cl. CPC H01M 4/134; C01B 32/184; C01B 32/194; C01B 32/198; C01B 32/225; C01B 32/23; H01M 4/0404; H01M 4/0416; H01M 4/1395; H01M 4/622; H01M 10/0525; H01M 10/054; H01M 10/4235; C01B 2204/22; C01B 2204/32; C01P 2002/78; C01P 2006/10; C01P 2006/12; C01P 2006/40; H01M 2004/021; H01M 2004/027

(57) ABSTRACT

Provided is an anode, an alkali metal battery comprising such an anode, and a production process; the anode comprising: (a) an anode current collector; (b) an anode active material layer comprising (i) multiple vertically oriented graphene sheets that are substantially perpendicular to the anode current collector, wherein the graphene sheets are inclined relative to the current collector at an angle approximately from 45 to 90 degrees and there are interstitial spaces or pores between graphene sheets; and (ii) an alkali metal, selected from lithium, sodium, potassium, or a combination thereof, wherein the alkali metal resides in the interstitial spaces or pores; and (c) a first binder that bonds the anode active layer or the graphene sheets to the anode current collector.

### FIELD

The present invention relates generally to the field of alkali metal battery (e.g., lithium metal battery or sodium metal battery) and, more particularly, to a lithium or sodium metal secondary battery having a graphene/metal composite anode and a process for producing this anode layer and the battery.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sep. 28, 2004); U.S. Pat. No. 6,936,381 (Aug. 30, 2005); and U.S. Pat. No. 7,247,408 (Jul. 24, 2007)] further proposed a multilayer anode structure including a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, including at least 3 or 4 layers, is too complex and too costly to make and use.

Protective coatings for Li anodes, such as glassy surface layers of LiI—Li₃PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Solid electrolytes typically have a low lithium ion conductivity, are difficult to produce and difficult to implement into a battery.

Furthermore, solid electrolyte does not have and cannot maintain a good contact with the lithium metal. A big physical gap tends to be created between the Cu foil surface (or lithium metal layer surface) and the solid electrolyte. This reduces the effectiveness of the electrolyte to support dissolution of lithium ions (during battery discharge), transport lithium ions, and allowing the lithium ions to re-deposit back to the lithium anode (during battery recharge).

Another major issue associated with the lithium metal anode is the continuing reactions between electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Among various advanced energy storage devices, alkali metal batteries, including Li-air (or Li—O₂), Na-air (or Na—O₂), Li—S, and Na—S batteries, are especially attractive due to their high specific energies. However, sodium metal batteries suffer from similar problems. The Li—O₂ battery is possibly the highest energy density electrochemical cell that can be configured today. The Li—O₂ cell has a theoretic energy density of 5.2 kWh/kg when oxygen mass is accounted for. A well configured Li—O₂ battery can achieve an energy density of 3,000 Wh/kg, 15-20 times greater than those of Li-ion batteries. However, current Li—O₂ batteries still suffer from poor energy efficiency, poor cycle efficiency, and dendrite formation and penetration issues.

One of the most promising energy storage devices is the lithium-sulfur (Li—S) cell since the theoretical capacity of Li is 3,861 mAh/g and that of S is 1,675 mAh/g. In its simplest form, a Li—S cell includes elemental sulfur as the positive electrode and lithium as the negative electrode. The lithium-sulfur cell operates with a redox couple, described by the reaction S₈+16Li↔8Li₂S that lies near 2.2 V with respect to Li⁺/Li^{o}. This electrochemical potential is approximately ⅔ of that exhibited by conventional positive electrodes (e.g. LiMnO₄). However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Assuming complete reaction to Li₂S, energy densities values can approach 2,500 Wh/kg and 2,800 Wh/l, respectively, based on the combined Li and S weights or volumes. If based on the total cell weight or volume, the energy densities can reach approximately 1,000 Wh/kg and 1,100 Wh/l, respectively. However, the current Li-sulfur cells reported by industry leaders in sulfur cathode technology have a maximum cell specific energy of 250-350 Wh/kg (based on the total cell weight), which is far below what is possible.

In summary, despite its great potential, the practical realization of the Li—S battery has been hindered by several obstacles, such as dendrite-induced internal shorting, low active material utilization efficiency, high internal resistance, self-discharge, and rapid capacity fading on cycling. The most serious problem of Li metal secondary (rechargeable) batteries remains to be the dendrite formation and penetration. Sodium metal batteries have similar dendrite problems.

A specific object of the present invention is to provide an anode-protecting layer to address the dendrite issue so that lithium metal and sodium metal secondary batteries can exhibit a long and stable charge-discharge cycle life without any internal shorting problems.

### SUMMARY

The present disclosure provides an anode comprising an oriented graphene-based protective layer for an alkali metal battery (lithium or sodium metal battery) and a process for producing such a protective layer and the battery. The disclosure also provides a lithium or sodium metal battery containing such a protective layer in the anode.

In certain embodiments, the provided anode or negative electrode for an alkali metal battery comprises: (a) an anode current collector; (b) an anode active material layer comprising (i) multiple vertically oriented graphene sheets that are substantially perpendicular to the anode current collector, wherein the graphene sheets are inclined relative to said current collector at an angle from 45 to 90 degrees and there are interstitial spaces or pores between graphene sheets; and (ii) an alkali metal, selected from lithium, sodium, potassium, or a combination thereof, wherein the alkali metal resides in the interstitial spaces or pores; and (c) a first binder that bonds the anode active layer or the graphene sheets to the anode current collector.

The oriented graphene layer may be chemically bonded to a surface of the anode current collector, such as a Cu foil. The anode current collector may be selected from, for instance, a Cu foil, a Cu-coated polymer film, a sheet of Ni foam, a porous layer of nano-filaments, such as graphene film, carbon nanofibers, carbon nano-tubes, etc. The oriented graphene layer is preferably chemically bonded or physically attached to a surface of the anode current collector and maintains an electric contact with the current collector. The multiple graphene sheets may be bonded together by a second binder or dispersed in said second binder, which is identical to or different than the first binder. The binder may be a polymer (preferably electrically and/or ionically conducting polymer), a carbon, a metal or a combination thereof

The graphene sheets are preferably produced from an exfoliated product of meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof.

The graphene sheets may comprise single-layer or few-layer graphene sheets, wherein said few-layer graphene sheets have 2-10 layers of stacked graphene planes having an inter-plane spacing doo from 0.3354 nm to 2.0 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the interstitial spaces have a pore size from 2 nm to 10 μm. Preferably, the interstitial spaces comprise interconnected pores to facilitate uptake and release of the alkali metal.

The present disclosure also provides an alkali metal battery comprising a cathode, an anode as herein disclosed, and an electrolyte or separator-electrolyte assembly disposed between the cathode and the anode. A porous separator may not be necessary if the electrolyte is a solid-state electrolyte. There can be a working electrolyte that resides in the anode, the separator, and/or the cathode.

In certain desired embodiments, the anode active material layer may initially comprise multiple vertically oriented graphene sheets only, without an anode active material (Li or Na metal) deposited in the interstitial spaces or pores. In such a battery cell, the anode contains a current collector and a layer of vertically oriented graphene sheets, but without a lithium metal or sodium metal or any other anode active material, such as graphite or Si particles, when the battery cell is manufactured. Such a battery cell having an initially lithium metal-free and sodium-free anode is commonly referred to as an “anode-less” lithium battery or sodium battery. For illustration purpose and using an anode-less lithium battery as an example, the lithium ions that are required for shuttling back and forth between the anode and the cathode are initially stored in the cathode active materials (e.g. Li in LiMn₂0₄ and LiMPO₄, where M=Ni, Co, F, Mn, etc.). During the first battery charge procedure, lithium ions (Li⁺) come out of the cathode active material, move through the electrolyte and then get deposited on a surface of the graphene sheets or in the pores. As this charging procedure continues, more lithium ions get deposited into the pores between graphene sheets or forming a lithium metal film or coating on surfaces of vertically aligned graphene sheets. Surprisingly, no lithium dendrites were found to grow toward the separator layer, in contrast to what was commonly observed in conventional lithium metal batteries.

Further, during the subsequent battery discharge of a conventional lithium metal battery, the lithium layer on an anode current collector surfaces decreases in thickness due to dissolution of lithium into the electrolyte to become lithium ions, creating a gap between the current collector and a solid-state electrolyte or separator. Such a gap would make the re-deposition of lithium ions back to the anode impossible during a subsequent recharge procedure.

In contrast, during the subsequent discharge of the presently disclosed lithium metal battery, the amount of lithium in the interstitial spaces or pores decreases, creating interstitial spaces between graphene sheets; but, the hosting graphene layer remains in good contact with the separator or solid-state electrolyte. This feature appears to enable the re-deposition of lithium ions without interruption. The same advantages were observed for sodium batteries similarly configured. It appears that the layer of vertically aligned graphene sheets is reversibly compressible.

In some embodiments, the disclosed anode initially has an amount of lithium, lithium alloy, sodium or sodium alloy as an anode active material residing in less than 20% by volume of the pores in the interstitial spaces.

The alkali metal battery may further comprise a polymer that is disposed between the anode and the separator or electrolyte, wherein the polymer covers the anode active layer and preferably also partially impregnates into the interstitial spaces or coated on the graphene sheets, wherein the polymer is selected from (i) an ion-conducting polymer having an lithium ion or sodium ion conductivity no less than 10⁻⁶ S/cm; (ii) a high-elasticity polymer having a recoverable tensile strain no less than 10% (typically from 10% to 1,500%) when measured without an additive or reinforcement dispersed therein, or (iii) an ion-conducting polymer which is also a high-elasticity polymer.

The high-elasticity polymer preferably comprises a a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

The elastic polymer refers to a polymer that is capable of reversibly deforming from 10% to 1,500% (or higher) when tested under tension. Upon release of the tension or tensile force, the polymer recoils or snaps back to substantially its original dimensions.

The high-elasticity polymer may comprise a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

The ion-conducting polymer may be selected poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, poly(ether urethane), polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyacrylic acid (PAA), poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof, a sulfonated derivative thereof, or a combination thereof.

The polymer may further comprise a lithium ion-conducting additive or lithium salt dispersed therein and selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)², lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)³, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLI, (ROCO₂Li)², (CH₂OCO₂Li)², Li₂S, LiₓSO_{y}, or a combination thereof, wherein X=F, Cl, I, or Br, R=a hydrocarbon group, x=0-1, y=1-4.

In certain embodiments, the high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In the alkali metal battery, the electrolyte may be selected from a liquid electrolyte, semi-liquid electrolyte, gel polymer electrolyte, solid polymer electrolyte, elastic solid electrolyte, inorganic solid electrolyte, a composite solid electrolyte, or a combination thereof, wherein the electrolyte is present in the anode, the separator, and/or the cathode. The electrolyte in the alkali metal battery may comprises an elastic solid electrolyte having a lithium ion or sodium ion conductivity no less than 10⁻⁶ S/cm and a recoverable elastic tensile strain no less than 10%.

The present disclosure also provides a process for producing the anode as herein disclosed, the process comprising: (a) preparing an anode current collector having two primary surfaces and providing and attaching a layer of vertically oriented graphene sheets to at least a primary surface, wherein the layer of vertically oriented graphene sheets comprise interstitial spaces or pores; and (b) impregnating the interstitial spaces or pores with lithium metal or sodium metal to form the anode.

In this process, the procedure of providing a layer of vertically oriented graphene sheets may comprise: (i) subjecting a carbon or graphite material to an expansion and exfoliation treatment selected from an oxidation, fluorination, bromination, chlorination, nitrogenation, intercalation, combined oxidation-intercalation, combined fluorination-intercalation, combined bromination-intercalation, combined chlorination-intercalation, combined nitrogenation-intercalation, mechanical shearing, ultrasonication, supercritical fluid exfoliation, electrochemical exfoliation, or a combination thereof to produce multiple graphene sheets; and (ii) compressing multiple graphene sheets using a wet compression or dry compression to align the graphene sheets substantially along one direction (this direction will be substantially perpendicular to a primary surface of the anode current collector).

Step (b) may comprise a procedure selected from metal melt impregnation or dipping, solution impregnation, chemical vapor deposition, physical vapor deposition, sputtering, spraying, brushing, painting, coating, casting, or a combination thereof.

In some embodiments, step (a) comprises applying a binder to bond the multiple graphene sheets together to form a layer of structural integrity and/or bonding the layer to a primary surface of the anode current collector.

The process may further comprise a procedure of combining the anode, a separator, a cathode, an electrolyte and a protective casing to form an alkali metal cell.

In certain embodiments, the procedure of providing a layer of vertically oriented graphene sheets comprises: A) preparing a graphene dispersion having multiple isolated graphene sheets dispersed in a liquid medium; B) subjecting the graphene dispersion to a forced assembly procedure, forcing the multiple graphene sheets to assemble into liquid medium-impregnated laminar graphene structure, wherein the multiple graphene sheets are substantially aligned along a desired direction; C) removing the liquid medium to obtain a dry and porous laminar graphene structure having a physical density from 0.1 to 1.7 g/cm³ and a specific surface area from 50 to 3,300 m²/g; and D) optionally impregnating the porous laminar graphene structure with a first resin binder to form a porous laminar graphene structure of structural integrity having substantially aligned graphene sheets.

Step D) may comprise (i) impregnating a plurality of the porous laminar graphene structures with a resin binder to form a plurality of laminar graphene composite structures each having substantially aligned graphene sheets; (ii) stacking the plurality of laminar graphene structures alternately with a plurality of layers of a sacrificial material to form a laminate comprising alternating layers of graphene composite structure and sacrificial material, wherein the sacrificial material layers have a layer thickness from 2 nm to 20 μm; (iii) bonding or attaching the laminate to a solid substrate layer with the constituent graphene sheets substantially perpendicular to the solid substrate, wherein one end each of the laminar graphene structures touches the solid substrate or bonded thereto; and (iv) removing the sacrificial material to form the layer of vertically oriented graphene sheets.

The procedure (iv) of removing the sacrificial material may comprise a procedure selected from dissolving, melting, vaporizing, etching, or carbonizing the sacrificial material, or a combination thereof.

The process may further comprise: (i) a step of cutting the porous laminar graphene structure of structural integrity to form one or a plurality of layers of substantially aligned graphene sheets and (ii) attaching a layer of substantially aligned graphene sheets to at least a primary surface of the anode current collector in such a manner that the substantially aligned graphene sheets are inclined relative to the current collector at an angle from approximately 45 to 90 degrees and there are interstitial spaces or pores between graphene sheets.

In some embodiments, the forced assembly procedure includes introducing the graphene dispersion, having an initial volume V₁, in a mold cavity cell and driving a piston into the mold cavity cell to reduce the graphene dispersion volume to a smaller value V₂, allowing excess liquid medium to flow out of the cavity cell and aligning the multiple graphene sheets along a desired direction.

The forced assembly procedure may include introducing the graphene dispersion in a mold cavity cell having an initial volume V₁, and applying a suction pressure through a porous wall of the mold cavity to reduce the graphene dispersion volume to a smaller value V₂, allowing excess liquid medium to flow out of the cavity cell through the porous wall and aligning the multiple graphene sheets along a desired direction.

In some embodiments, the forced assembly procedure includes introducing a first layer of the graphene dispersion onto a surface of a supporting conveyor and driving the layer of graphene suspension supported on the conveyor through at least a pair of pressing rollers to reduce a thickness of the graphene dispersion layer and align the multiple graphene sheets along a direction parallel to the conveyor surface for forming a layer of laminar graphene structure.

The process may further include a step of introducing a second layer of the graphene dispersion onto a surface of the layer of laminar graphene structure to form a two layer laminar structure, and driving the two-layer laminar structure through at least a pair of pressing rollers to reduce a thickness of the second layer of graphene dispersion and align the multiple graphene sheets along a direction parallel to the conveyor surface for forming a layer of laminar graphene structure.

The process may further include a step of compressing or roll-pressing the laminar structure to reduce a layer thickness in the laminar structure and improve the orientation of graphene sheets. The process is preferably a roll-to-roll process wherein the forced assembly procedure includes feeding the supporting conveyor, in a continuous film form, from a feeder roller to a deposition zone, continuously or intermittently depositing said graphene dispersion onto a surface of the supporting conveyor film to form the layer of graphene dispersion thereon, and collecting the layer of laminar graphene structure supported on conveyor film on a collector roller.

### BRIEF DESCRIPTION OF THE DRAWINGS

FIG. 1(A) Schematic drawing illustrating the processes for producing intercalated and/or oxidized graphite, subsequently exfoliated graphite worms, separated graphene sheets, and conventional paper, mat, film, and membrane of simply aggregated graphite flakes, graphene sheets, etc.;

FIG. 1(B) An SEM image of exfoliated carbon (exfoliated carbon worms);

FIG. 1(C) A TEM image of graphene sheets;

FIG. 1(D) Schematic drawing illustrating a layer of oriented graphene sheets, wherein graphene sheets are laid on Y-Z planes and perpendicular to an anode current collector according to certain embodiments of the present disclosure;

FIG. 1(E) A continuous process for producing a structure of aligned graphene sheets, including feeding dry powder of graphene sheets into the gap between a pair of two counter-rotating rollers or the gaps between several pairs of rollers;

FIG. 1(F) A schematic drawing to illustrate an example of a compressing and consolidating operation (using a mold cavity cell 302 equipped with a piston or ram 308) for forming a layer of highly compacted and oriented graphene sheets;

FIG. 1(G) Schematic drawing to illustrate another example of a compressing and consolidating operation (using a mold cavity cell equipped with a piston or ram) for forming a layer of highly compacted and oriented graphene sheets.

FIG. 2(A) Schematic of an alkali metal cell having an elastic and ion-conducting polymer-based protective layer covering the anode active layer (comprising a layer of vertically aligned graphene sheets impregnated with an alkali metal) according to certain embodiments of the present disclosure;

FIG. 2(B) Schematic of an alkali metal cell having an anode active layer (comprising a layer of vertically aligned graphene sheets impregnated with an alkali metal) according to certain embodiments of the present disclosure.

FIG. 3 Schematic of a prior art lithium metal battery cell.

FIG. 4 Schematic of a presently disclosed lithium metal battery cell (upper diagram) containing an anode current collector (e.g. Cu foil) and a layer of oriented graphene sheets having empty interstitial spaces or pores (no lithium metal residing in the pores) when the cell is manufactured or in a fully discharged state), a separator, and a cathode active material layer, which is typically composed of particles of a cathode active material, a conductive additive (not shown) and a resin binder (not shown). A cathode current collector supporting the cathode active layer is also shown. The lower diagram shows the graphene layer with pores now deposited with or impregnated by lithium metal when the battery is in a charged state.

FIG. 5 An example of a layer of oriented graphene sheets wherein the graphene sheets are laid on Y-Z planes and perpendicular to an anode current collector surface according to certain embodiments of the present disclosure.

### DETAILED DESCRIPTION

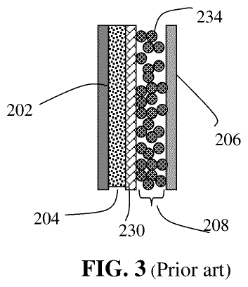

As schematically illustrated in FIG. 3, a prior art lithium metal cell is typically composed of an anode current collector 202 (e.g. Cu foil), an anode active material layer 204 (a foil of lithium metal or lithium-rich metal alloy), a porous membrane or solid-state electrolyte layer as a separator 230, a cathode active material layer 208 (containing a cathode active material, such as V₂O₅ and MoS₂ particles 234, and conductive additives that are all bonded by a resin binder, not shown), a cathode current collector 206 (e.g. Al foil), and an electrolyte disposed in ionic contact with both the anode active material layer 204 (also simply referred to as the “anode layer”) and the cathode active material layer 208 (or simply “cathode layer”). The entire cell is encased in a protective housing, such as a thin plastic-aluminum foil laminate-based envelop. A prior art sodium metal cell is similarly configured, but the anode active material layer is a foil of sodium metal or sodium-rich metal, or particles of sodium.

The prior art lithium or sodium metal cell is typically made by a process that includes the following steps: (a) The first step is mixing and dispersing particles of the cathode active material (e.g. lithium transition metal oxide particles), a conductive filler (e.g. acetylene black), a resin binder (e.g. PVDF) in a solvent (e.g. NMP) to form a cathode slurry; (b) The second step includes coating the cathode slurry on the surface(s) of an Al foil and drying the slurry to form a dried cathode electrode coated on the Al foil; (c) The third step includes laminating a Cu foil (as an anode current collector), a sheet of Li or Na foil (or lithium alloy or sodium alloy foil), a porous separator layer, and a cathode electrode-coated Al foil sheet together to form a 5-layer assembly, which is cut and slit into desired sizes and stacked to form a rectangular structure (as an example of shape) or rolled into a cylindrical cell structure; (d) The rectangular or cylindrical laminated structure is then encased in an aluminum-plastic laminated envelope or steel casing; and (c) A liquid electrolyte is then injected into the laminated structure to make a lithium battery cell.

Due to the high specific capacity of lithium metal and sodium metal, the highest battery energy density can be achieved by alkali metal rechargeable batteries that utilize a lithium metal or sodium metal as the anode active material, provided that a solution to the safety problem can be formulated. These cells include (a) the traditional Li or Na metal battery having a Li insertion or Na insertion compound in the cathode, (b) the Li-air or Na—O₂ cell that uses oxygen as a cathode instead of metal oxide (and Li or sodium metal as an anode instead of graphite or hard carbon), (c) the Li-sulfur or Na—S cell, and (d) the lithium-selenium cell or sodium-selenium cell.

The Li—O₂ battery is possibly the highest energy density electrochemical cell that can be configured today. The Li—O₂ cell has a theoretic energy density of 5,200 Wh/kg when oxygen mass is accounted for. A well configured Li—O₂ battery can achieve an energy density of 3,000 Wh/kg, which is 15-20 times greater than those of Li-ion batteries. However, current Li—O₂ batteries still suffer from poor energy efficiency, poor cycle efficiency, and dendrite formation issues. In the Li—S cell, elemental sulfur(S) as a cathode material exhibits a high theoretical Li storage capacity of 1,672 mAh/g. With a Li metal anode, the Li—S battery has a theoretical energy density of ˜1,600 Wh/kg. Despite its great potential, the practical realization of the Li—S battery has been hindered by several obstacles, such as low utilization of active material, high internal resistance, self-discharge, and rapid capacity fading on cycling. These technical barriers are due to the poor electrical conductivity of elemental sulfur, the high solubility of lithium polysulfides in organic electrolyte, the formation of inactivated Li₂S, and the formation of Li dendrites on the anode. Despite great efforts worldwide, dendrite formation remains the single most critical scientific and technological barrier against widespread implementation of all kinds of high energy density batteries having a Li metal anode.

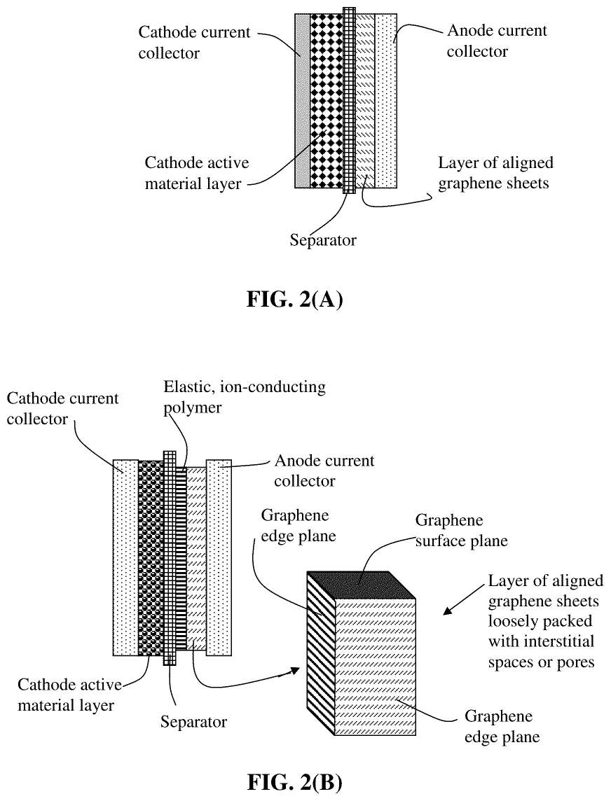

We have discovered a highly dendrite-resistant, oriented graphene sheets-enabled Li metal cell or Na metal cell configuration that exhibits a high energy and/or high power density. As schematically illustrated in FIGS. 2(A) and 2(B), each cell contains a layer of vertically aligned graphene sheets as an anode protective layer. This graphene layer is composed of oriented graphene sheets and interstitial spaces or pores to accommodate lithium or sodium.

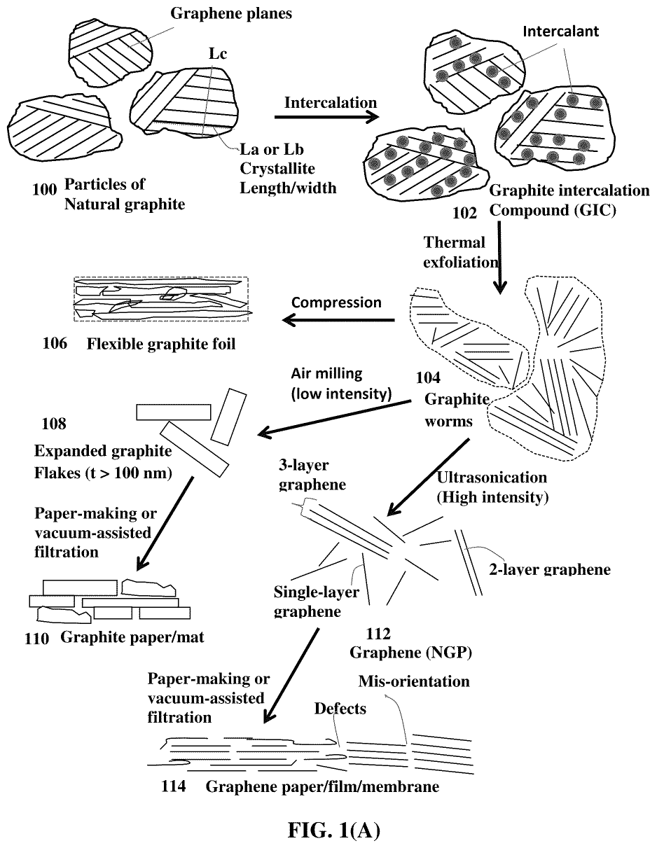

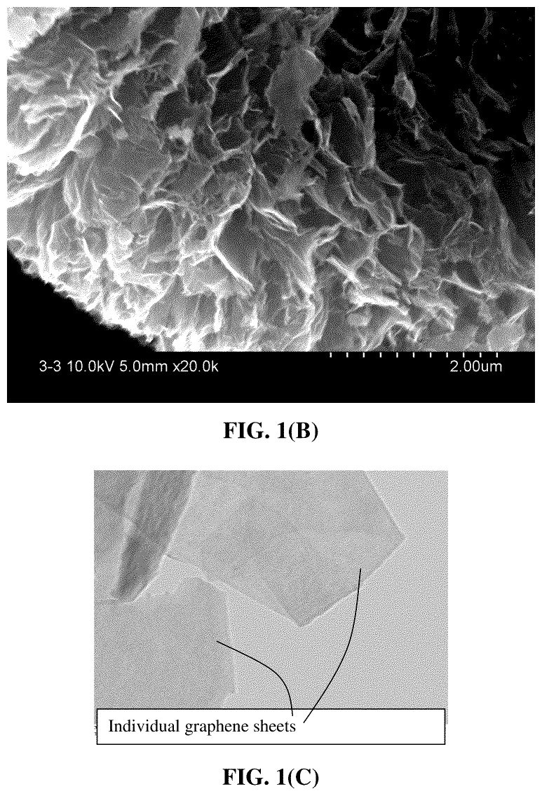

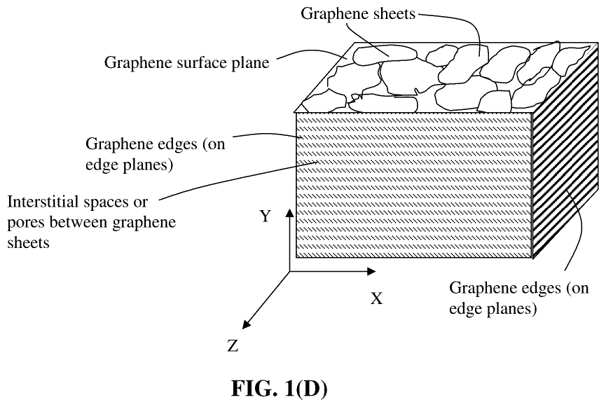

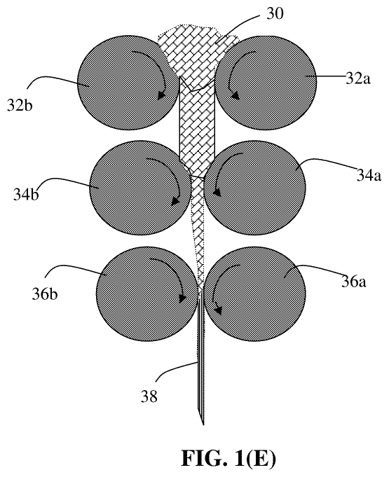

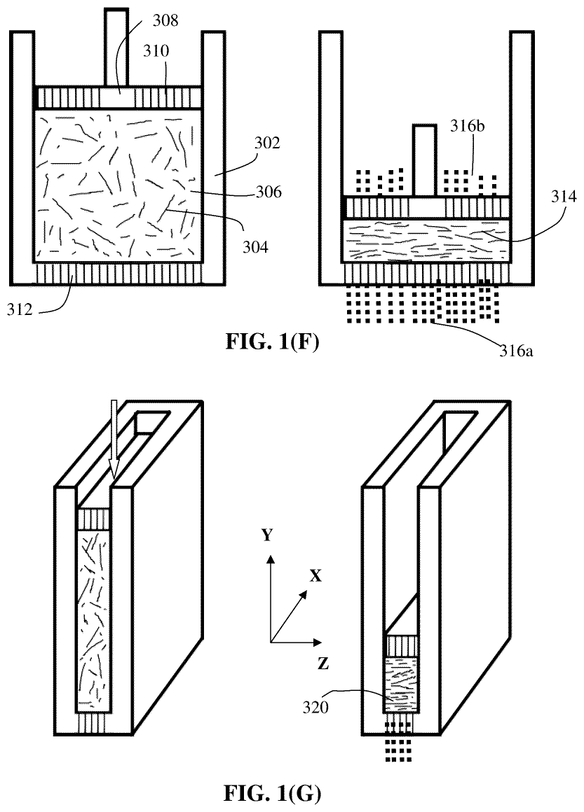

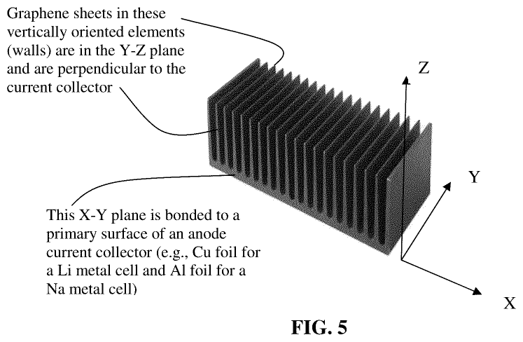

In certain embodiments, the provided anode or negative electrode for an alkali metal battery comprises: (a) an anode current collector; (b) an anode active material layer comprising (i) multiple vertically oriented graphene sheets that are substantially perpendicular to the anode current collector (e.g., FIG. 1(D) and FIG. 5), wherein the graphene sheets are inclined relative to the current collector at an angle from 45 to 90 degrees and there are interstitial spaces or pores between graphene sheets; and (ii) an alkali metal, selected from lithium, sodium, potassium, or a combination thereof, wherein the alkali metal resides in the interstitial spaces or pores; and (c) a first binder that bonds the anode active layer or the graphene sheets to the anode current collector.

The oriented graphene layer may be chemically bonded to a surface of the anode current collector, such as a Cu foil. The anode current collector may be selected from, for instance, a Cu foil, a Cu-coated polymer film, a sheet of Ni foam, a porous layer of nano-filaments, such as graphene film, carbon nanofibers, carbon nano-tubes, etc. The oriented graphene layer is preferably chemically bonded or physically attached to a surface of the anode current collector and maintains an electric contact with the current collector. The multiple graphene sheets may be bonded together by a second binder, which is identical to or different than the first binder.

The graphene sheets are preferably produced from an exfoliated product of meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof.

The graphene sheets may comprise single-layer or few-layer graphene sheets, wherein said few-layer graphene sheets have 2-10 layers of stacked graphene planes having an inter-plane spacing d₀₀₂ from 0.3354 nm to 2.0 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the interstitial spaces have a pore size from 2 nm to 10 μm. Preferably, the interstitial spaces comprise interconnected pores to facilitate uptake and release of the alkali metal.

The present disclosure also provides an alkali metal battery comprising a cathode, an anode as herein disclosed, and an electrolyte or separator-electrolyte assembly disposed between the cathode and the anode. A porous separator may not be necessary if the electrolyte is a solid-state electrolyte. There can be a working electrolyte that resides in the anode, the separator, and/or the cathode.

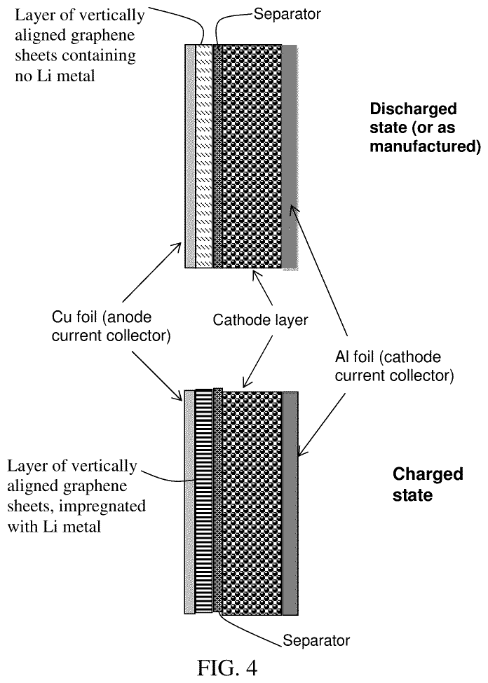

In certain desired embodiments, as illustrated in the upper portion of FIG. 4, the anode active material layer may initially comprise multiple vertically oriented graphene sheets only, without an anode active material (Li or Na metal) deposited in the interstitial spaces or pores. In such a battery cell, the anode contains a current collector and a layer of vertically oriented graphene sheets, but without a lithium metal or sodium metal or any other anode active material, such as graphite or Si particles, when the battery cell is manufactured. Such a battery cell having an initially lithium metal-free and sodium-free anode is commonly referred to as an “anode-less” lithium battery or sodium battery. For illustration purpose and using an anode-less lithium battery as an example, the lithium ions that are required for shuttling back and forth between the anode and the cathode are initially stored in the cathode active materials (e.g. Li in LiMn₂0₄ and LiMPO₄, where M=Ni, Co, F, Mn, etc.). During the first battery charge procedure, lithium ions (Li⁺) come out of the cathode active material, move through the electrolyte and then get deposited on a surface of the graphene sheets or in the pores. As this charging procedure continues, more lithium ions get deposited into the pores between graphene sheets or forming a lithium metal film or coating on surfaces of vertically aligned graphene sheets. Surprisingly, no lithium dendrites were found to grow toward the separator layer, in contrast to what was commonly observed in conventional lithium metal batteries.

Further, during the subsequent battery discharge of a conventional lithium metal battery, the lithium layer on an anode current collector surfaces decreases in thickness due to dissolution of lithium into the electrolyte to become lithium ions, creating a gap between the current collector and a solid-state electrolyte or separator. Such a gap would make the re-deposition of lithium ions back to the anode impossible during a subsequent recharge procedure.

In contrast, during the subsequent discharge of the presently disclosed lithium metal battery, the amount of lithium in the interstitial spaces or pores decreases, creating interstitial spaces between graphene sheets; but, the hosting graphene layer remains in good contact with the separator or solid-state electrolyte. This feature appears to enable the re-deposition of lithium ions without interruption. The same advantages were observed for sodium batteries similarly configured. It appears that the layer of vertically aligned graphene sheets is reversibly compressible.

In certain other embodiments, this layer of oriented graphene sheets can be lithiated (loaded with Li; e.g. Li⁺ ions permeated into pores to deposit on nearby graphene sheet surfaces) or sodiated (loaded with Na) before or after the cell is made. For instance, when the cell is made, a foil or particles of lithium or sodium metal (or metal alloy) may be implemented at the anode (e.g. between the graphene layer and the porous separator) to supply this graphene layer with lithium or sodium. During the first battery discharge cycle, lithium (or sodium) is ionized, supplying lithium (or sodium) ions (Li⁺ or Na⁺) into electrolyte. These Li⁺ or Na⁺ ions migrate to the cathode side and get captured by and stored in the cathode active material (e.g. vanadium oxide, MoS₂, S, etc.).

During the subsequent re-charge cycle of the battery, Li⁺ or Na⁺ ions are released by the cathode active material and migrate back to the anode. These Li⁺ or Na⁺ ions naturally diffuse through the electrolyte and reach the graphene surfaces or spaces between graphene sheets. In this manner, the graphene layer is said to be lithiated or sodiated. Alternatively, the graphene layer can be lithiated or sodiated (herein referred to as “pre-lithiated” or “pre-sodiated”) electrochemically prior to being incorporated as an anode protective layer into the cell structure. This can be accomplished by bringing a graphene layer in contact with a lithium or sodium foil in the presence of a liquid electrolyte, or by implementing a graphene layer as a working electrode and a lithium/sodium foil or rod as a counter-electrode in an electrochemical reactor chamber containing a liquid electrolyte. By introducing an electric current between the working electrode and the counter-electrode, one can introduce lithium or sodium into the pores of the graphene layer.

The alkali metal battery may further comprise a polymer that is disposed between the anode and the separator or electrolyte (FIG. 2(B)), wherein the polymer covers the anode active layer and preferably also partially impregnates into the interstitial spaces or coated on the graphene sheets, wherein the polymer is selected from (i) an ion-conducting polymer having an lithium ion or sodium ion conductivity no less than 106 S/cm; (ii) a high-elasticity polymer having a recoverable tensile strain no less than 10% (typically from 10% to 1,500%) when measured without an additive or reinforcement dispersed therein, or (iii) an ion-conducting polymer which is also a high-elasticity polymer.

The high-elasticity polymer preferably comprises a a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

The elastic polymer refers to a polymer that is capable of reversibly deforming from 10% to 1,500% (or higher) when tested under tension. Upon release of the tension or tensile force, the polymer recoils or snaps back to substantially its original dimensions.

The high-elasticity polymer may comprise a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

The ion-conducting polymer may be selected poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, poly(ether urethane), polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyacrylic acid (PAA), poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof, a sulfonated derivative thereof, or a combination thereof.

The polymer may further comprise a lithium ion-conducting additive or lithium salt dispersed therein and selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)², lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)³, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)², (CH₂OCO₂Li)², Li₂S, LiₓSO_{y}, or a combination thereof, wherein X=F, Cl, I, or Br, R=a hydrocarbon group, x=0-1, y=1-4.

In certain embodiments, the high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In the alkali metal battery, the electrolyte may be selected from a liquid electrolyte, semi-liquid electrolyte, gel polymer electrolyte, solid polymer electrolyte, elastic solid electrolyte, inorganic solid electrolyte, a composite solid electrolyte, or a combination thereof, wherein the electrolyte is present in the anode, the separator, and/or the cathode. The electrolyte in the alkali metal battery may comprises an elastic solid electrolyte having a lithium ion or sodium ion conductivity no less than 10⁻⁶ S/cm and a recoverable elastic tensile strain no less than 10%.

We have discovered that this protective layer of oriented graphene sheets provides several unexpected benefits: (a) the formation of dendrite has been essentially eliminated; (b) uniform deposition of lithium back to the anode side is readily achieved; (c) the layer ensures smooth and uninterrupted transport of lithium ions from/to the graphene surfaces and anode current collector surface and through the interface between the separator and the protective layer with minimal interfacial resistance; and (d) cycle stability can be significantly improved and cycle life increased.

Graphene is a single-atom thick layer of sp² carbon atoms arranged in a honeycomb-like lattice. Graphene can be readily prepared from graphite, activated carbon, graphite fibers, carbon black, and meso-phase carbon beads. Single-layer graphene and its slightly oxidized version (GO) can have a specific surface area (SSA) as high as 2670 m²/g. It is this high surface area that dramatically reduces the effective electrode current density, which in turn significantly reduces or eliminates the possibility of Li dendrite formation.

The graphene material may be selected from pristine graphene, graphene oxide, reduced graphene oxide, graphene fluoride, graphene chloride, graphene bromide, graphene iodide, hydrogenated graphene, nitrogenated graphene, doped graphene (e.g. nitrogen-doped graphene), chemically functionalized graphene, or a combination thereof. The starting graphitic material for producing any one of the above graphene materials may be selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof. Production methods for these graphene sheets are well-known in the art.

For instance, the graphene oxide (GO) may be obtained by immersing powders or filaments of a starting graphitic material (e.g. natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). The resulting graphite oxide particles may then be subjected to thermal exfoliation or ultrasonic wave-induced exfoliation to produce GO sheets.

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated including trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultrasonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

Due to the weak van der Waals forces holding the parallel graphene layers, natural graphite can be treated so that the spacing between the graphene layers can be appreciably opened up so as to provide a marked expansion in the c-axis direction, and thus form an expanded graphite structure in which the laminar character of the carbon layers is substantially retained. The process for manufacturing flexible graphite is well-known in the art. In general, flakes of natural graphite (e.g. 100 in FIG. 1(A)) are intercalated in an acid solution to produce graphite intercalation compounds (GICs, 102). The GICs are washed, dried, and then exfoliated by exposure to a high temperature for a short period of time. This causes the flakes to expand or exfoliate in the c-axis direction of the graphite up to 80-300 times of their original dimensions. The exfoliated graphite flakes are vermiform in appearance and, hence, are commonly referred to as worms 104 (e.g., FIG. 1(B)). These worms of graphite flakes which have been greatly expanded can be formed without the use of a binder into cohesive or integrated sheets of expanded graphite, e.g. webs, papers, strips, tapes, foils, mats or the like (typically referred to as “flexible graphite” 106) having a typical density of about 0.04-2.0 g/cm³ for most applications. Graphite worms may be subjected to high-intensity shearing or ultrasonication to produce isolated graphene sheets (e.g., FIG. 1(C)).

Compression or re-compression of graphene sheets into a layer or block of recompressed graphene sheets having a preferred orientation (e.g., as schematically illustrated in FIG. 1(D)) can be accomplished by using several procedures, which can be classified into two broad categories: dry pressing/rolling or wet pressing/rolling. The dry process entails mechanically pressing graphene sheets in one direction (uniaxial compression) without the presence of a liquid medium. Alternatively, as schematically illustrated in FIG. 1(E), the process includes feeding dry powder of graphene sheets 30 into the gap between two counter-rotating rollers (e.g. 32a and 32b) to form a slightly compressed layer of “re-compressed graphene sheets,” which are then further compressed to form a thinner layer of further re-compressed graphene sheets (containing aligned graphene sheets) by directing the material into the gap between another two rollers (e.g. 34a and 34b). If necessary, another pair or multiple pairs of rollers (e.g. 36a and 36b) can be implemented to further reduce the layer thickness and further improve the degree of graphene orientation, resulting in a layer 38 of relatively well-aligned graphene sheets.

A layer of oriented graphene structure (or multiple layers of such a structure stacked and/or bonded together) may be cut and slit to produce a desired number of pieces of the oriented graphene structure. Assuming that each piece is a cube or tetragon, each cube will then have 4 graphene sheet edge planes and 2 graphene surface planes as illustrated in the bottom right portion of FIG. 1(D). When such a piece is implemented as an anode layer, the layer can be positioned and aligned in such a manner that one of the graphene edge planes is substantially parallel to the anode layer or the porous separator layer and constituent graphene sheets are substantially perpendicular to the anode current collector. This graphene edge plane typically is very close to or actually in direct contact with the separator layer or the protective polymer layer, if present. Such an orientation is found to be conducive to entry and exiting of ions into/from the interstitial spaces between graphene planes in the electrode, leading to significantly improved high-rate capability and high power density.

It may be noted that the same procedures can be used to produce a wet layer of graphene sheets provided the starting graphene sheets are dispersed in a liquid medium. This liquid medium may be simply water or solvent, which should be removed upon completion of the roll-pressing procedure. The liquid medium may be or may contain a resin binder that helps to bond graphene sheets together, although a resin binder is not required.

Thus, the present invention also provides a wet process for producing a layer of oriented graphene sheets for use as an alkali metal anode layer. In a preferred embodiment, the wet process (method) comprises: (a) preparing a dispersion or slurry having graphene sheets dispersed in a liquid medium; and (b) subjecting the suspension to a forced assembly procedure, forcing the graphene sheets to assemble into oriented graphene sheet structure, wherein liquid medium resides in the inter-graphene spaces in the structure of oriented graphene sheets. The graphene sheets are substantially aligned along a desired direction. Upon drying, the recompressed graphene sheet structure has a physical density from 0.1 to 1.7 g/cm³ (more typically 0.7-1.3 g/cm³) and a specific surface area from 20 to 1,500 m²/g, when measured in a dried state without the liquid.

In some desired embodiments, the forced assembly procedure includes introducing an graphene sheet suspension, having an initial volume V₁, in a mold cavity cell and driving a piston into the mold cavity cell to reduce the suspension volume to a smaller value V₂, allowing excess liquid medium to flow out of the cavity cell (e.g. through holes of the mold cavity cell or of the piston) and aligning the multiple graphene sheets along a direction at an angle from approximately 45° to 90° relative to the movement direction of the piston.

FIG. 1(F) provides a schematic drawing to illustrate an example of a compressing and consolidating operation (using a mold cavity cell 302 equipped with a piston or ram 308) for forming a layer of highly compacted and oriented graphene sheets 314. Contained in the chamber (mold cavity cell 302) is a suspension (or slurry) that is composed of graphene sheets 304 randomly dispersed in a liquid medium 306. As the piston 308 is driven downward, the volume of the suspension is decreased by forcing excess liquid electrolyte to flow through minute channels 312 on a mold wall or through small channels 310 of the piston. These small channels can be present in any or all walls of the mold cavity and the channel sizes can be designed to permit permeation of the liquid medium, but not the solid graphene sheets. The excess liquid is shown as 316a and 316b on the right diagram of FIG. 1(E). As a result of this compressing and consolidating operation, graphene sheets 314 are aligned parallel to the bottom plane or perpendicular to the layer thickness direction.

Shown in FIG. 1(G) is a schematic drawing to illustrate another example of a compressing and consolidating operation (using a mold cavity cell equipped with a piston or ram) for forming a layer of highly compacted and oriented graphene sheets 320. The piston is driven downward along the Y-direction. The graphene sheets are aligned on the X-Z plane and perpendicular to X-Y plane (along the Z- or thickness direction). This layer of oriented graphene sheets can be attached to a current collector (e.g. a Cu foil) that is basically represented by the X-Y plane. In the resulting electrode, graphene sheets are aligned perpendicular to the current collector. Such an orientation is conducive to a faster ion intercalation into and out of the spaces between graphene sheets and, hence, leads to a higher power density as compared to the corresponding electrode featuring graphene sheets being aligned parallel to the current collector plane (the graphene surface plane, not the edge plane, being parallel to the separator plane).

In summary, a process for producing the anode as herein disclosed may comprise: (a) preparing an anode current collector having two primary surfaces and providing and attaching a layer of vertically oriented graphene sheets to at least a primary surface, wherein the layer of vertically oriented graphene sheets comprise interstitial spaces or pores; and (b) impregnating the interstitial spaces or pores with lithium metal or sodium metal to form the anode.

In this process, the procedure of providing a layer of vertically oriented graphene sheets may comprise: (i) subjecting a carbon or graphite material to an expansion and exfoliation treatment selected from an oxidation, fluorination, bromination, chlorination, nitrogenation, intercalation, combined oxidation-intercalation, combined fluorination-intercalation, combined bromination-intercalation, combined chlorination-intercalation, combined nitrogenation-intercalation, mechanical shearing, ultrasonication, supercritical fluid exfoliation, electrochemical exfoliation, or a combination thereof to produce multiple graphene sheets; and (ii) compressing multiple graphene sheets using a wet compression or dry compression to align the graphene sheets substantially along one direction (this direction will be substantially perpendicular to a primary surface of the anode current collector).

Step (b) may comprise a procedure selected from metal melt impregnation or dipping, solution impregnation, chemical vapor deposition, physical vapor deposition, sputtering, spraying, brushing, painting, coating, casting, or a combination thereof.

In some embodiments, step (a) comprises applying a binder to bond the multiple graphene sheets together to form a layer of structural integrity and/or bonding the layer to a primary surface of the anode current collector.

The process may further comprise a procedure of combining the anode, a separator, a cathode, an electrolyte and a protective casing to form an alkali metal cell.

In certain embodiments, the procedure of providing a layer of vertically oriented graphene sheets comprises: A) preparing a graphene dispersion having multiple isolated graphene sheets dispersed in a liquid medium; B) subjecting the graphene dispersion to a forced assembly procedure, forcing the multiple graphene sheets to assemble into liquid medium-impregnated laminar graphene structure, wherein the multiple graphene sheets are substantially aligned along a desired direction; C) removing the liquid medium to obtain a dry and porous laminar graphene structure having a physical density from 0.1 to 1.7 g/cm³ and a specific surface area from 50 to 3,300 m²/g; and D) optionally impregnating the porous laminar graphene structure with a first resin binder to form a porous laminar graphene structure of structural integrity having substantially aligned graphene sheets.

Step D) may comprise (i) impregnating a plurality of the porous laminar graphene structures with a resin binder to form a plurality of laminar graphene composite structures each having substantially aligned graphene sheets; (ii) stacking the plurality of laminar graphene structures alternately with a plurality of layers of a sacrificial material to form a laminate comprising alternating layers of graphene composite structure and sacrificial material, wherein the sacrificial material layers have a layer thickness from 2 nm to 20 μm; (iii) bonding or attaching the laminate to a solid substrate layer with the constituent graphene sheets substantially perpendicular to the solid substrate, wherein one end each of the laminar graphene structures touches the solid substrate or bonded thereto; and (iv) removing the sacrificial material to form the layer of vertically oriented graphene sheets. An example of this layer is illustrated in FIG. 5.

The procedure (iv) of removing the sacrificial material may comprise a procedure selected from dissolving, melting, vaporizing, etching, or carbonizing the sacrificial material, or a combination thereof. By removing the alternating layers of sacrificial material, one obtains gaps or pores between walls of graphene sheets vertically aligned relative to the anode current collector.

The process may further comprise: (i) a step of cutting the porous laminar graphene structure of structural integrity to form one or a plurality of layers of substantially aligned graphene sheets and (ii) attaching a layer of substantially aligned graphene sheets to at least a primary surface of the anode current collector in such a manner that the substantially aligned graphene sheets are inclined relative to the current collector at an angle from approximately 45 to 90 degrees and there are interstitial spaces or pores between graphene sheets.

In some embodiments, the forced assembly procedure includes introducing the graphene dispersion, having an initial volume V₁, in a mold cavity cell and driving a piston into the mold cavity cell to reduce the graphene dispersion volume to a smaller value V₂, allowing excess liquid medium to flow out of the cavity cell and aligning the multiple graphene sheets along a desired direction.

The forced assembly procedure may include introducing the graphene dispersion in a mold cavity cell having an initial volume V₁, and applying a suction pressure through a porous wall of the mold cavity to reduce the graphene dispersion volume to a smaller value V₂, allowing excess liquid medium to flow out of the cavity cell through the porous wall and aligning the multiple graphene sheets along a desired direction.

In some embodiments, the forced assembly procedure includes introducing a first layer of the graphene dispersion onto a surface of a supporting conveyor and driving the layer of graphene suspension supported on the conveyor through at least a pair of pressing rollers to reduce a thickness of the graphene dispersion layer and align the multiple graphene sheets along a direction parallel to the conveyor surface for forming a layer of laminar graphene structure.

The process may further include a step of introducing a second layer of the graphene dispersion onto a surface of the layer of laminar graphene structure to form a two layer laminar structure, and driving the two-layer laminar structure through at least a pair of pressing rollers to reduce a thickness of the second layer of graphene dispersion and align the multiple graphene sheets along a direction parallel to the conveyor surface for forming a layer of laminar graphene structure.

The process may further include a step of compressing or roll-pressing the laminar structure to reduce a layer thickness in the laminar structure and improve the orientation of graphene sheets. The process is preferably a roll-to-roll process wherein the forced assembly procedure includes feeding the supporting conveyor, in a continuous film form, from a feeder roller to a deposition zone, continuously or intermittently depositing said graphene dispersion onto a surface of the supporting conveyor film to form the layer of graphene dispersion thereon, and collecting the layer of laminar graphene structure supported on conveyor film on a collector roller.

In certain embodiments, in the alkali metal battery, the layer of oriented graphene sheets further comprises a polymer that impregnates into the pores or is coated on or bonded to surfaces of the pore walls, wherein the polymer comprises an elastomer, an elastic polymer, an electron-conducting polymer, an ion-conducting polymer, or a combination thereof.

Most of these polymers can be initially in a monomer state that is in a liquid form or can be made into a liquid or solution state (e.g. via melting or dissolution in a liquid solvent). The monomer can be mixed with an initiator and an optional crosslinking agent to form a reacting mass, which is deposited into the pores or interstitial spaces of the graphene layer, followed by polymerization and crosslinking, where appropriate. Alternatively, these polymers can be in a non-crosslinked form that is soluble in a liquid solvent. The liquid solution containing a polymer dissolved in a liquid solvent and a curing agent (or crosslinking agent), also dissolved or dispersed in the solution, can also be deposited onto into the pores of the interstices between graphene sheets, followed by removal of the liquid solvent and necessary crosslinking via heat or UV curing. Deposition of the reactive polymer or polymer solution may be conducted using spraying, spray-coating, coating, casting, solution immersion (dipping), etc.

The elastic polymer preferably contains a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC). Then, the ETPTA monomer/solvent/initiator solution may be cast to form ETPTA a monomer/initiator layer on a glass surface. The layer can then be thermally cured to obtain a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

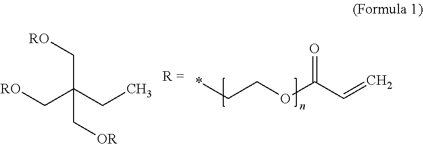

As another example, the high-elasticity polymer for anode lithium foil/coating protection may be based on cationic polymerization and cross-linking of the cyanoethyl polyvinyl alcohol (PVA-CN, Formula 2) in succinonitrile (SN).

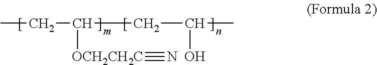

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, the solution may be deposited to form a thin layer of reacting mass, PVA-CN/LiPF₆, which is subsequently heated at a temperature (e.g. from 75 to 100° C.) for 2 to 8 hours to obtain a high-elasticity polymer. During this process, cationic polymerization and cross-linking of cyano groups on the PVA-CN may be initiated by PFs, which is derived from the thermal decomposition of LiPF₆ at such an elevated temperature.

It is essential or advantageous for these materials to form a lightly cross-linked network of polymer chains. In other words, the network polymer or cross-linked polymer should have a relatively low degree of cross-linking or low cross-link density to impart a high elastic deformation.

The ion-conducting polymer is preferably selected from poly(ethylene oxide) (PEO), polypropylene oxide (PPO), poly(ethylene glycol) (PEG), poly(acrylonitrile) (PAN), poly(methyl methacrylate) (PMMA), poly(vinylidene fluoride) (PVdF), Poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol) (PVACN), polyacrylic acid (PAA), a pentaerythritol tetraacrylate (PETEA)-based polymer, an aliphatic polycarbonate (including poly(vinylene carbonate) (PVC), poly(ethylene carbonate) (PEC), poly(propylene carbonate) (PPC), and poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof.

The electron-conducting polymer preferably comprises chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In certain embodiments, the elastomer, elastic polymer, electron-conducting polymer or ion-conducting polymer further contains a lithium salt dispersed therein (in the polymer) and the lithium salt is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LIN (CF₃SO₂)², lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)³, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

Electrolyte is an important ingredient in a battery. A wide range of electrolytes can be used for practicing the instant invention. Most preferred are non-aqueous, polymer gel, and solid-state electrolytes although other types can be used. Solid polymer, polymer gel, inorganic solid-state, and composite electrolytes are preferred over liquid electrolytes.

The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly including a mixed solvent comprising ethylene carbonate (EC) and at least one kind of non-aqueous solvent whose melting point is lower than that of aforementioned ethylene carbonate and whose donor number is 18 or less (hereinafter referred to as a second solvent) may be preferably employed. This non-aqueous solvent is advantageous in that it is (a) effective in suppressing the reductive or oxidative decomposition of electrolyte; and (b) high in conductivity. A non-aqueous electrolyte solely composed of ethylene carbonate (EC) is advantageous in that it is relatively stable against carbonaceous filament materials. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃) and bis-trifluoromethyl sulfonylimide lithium [LiN(CF₃SO₂)²]. Among them, LiPF₆, LiBF₄ and LiN(CF₃SO₂)² are preferred. The content of aforementioned electrolytic salts in the non-aqueous solvent is preferably 0.5 to 3.5 mol/l.

For sodium metal batteries, the organic electrolyte may contain an alkali metal salt preferably selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)²), bis-trifluoromethyl sulfonylimide potassium (KN(CF₃SO₂)²), an ionic liquid salt, or a combination thereof.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane) sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl)imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a battery.

The cathode active material may be selected from a wide variety of oxides, such as lithium-containing nickel oxide, cobalt oxide, nickel-cobalt oxide, vanadium oxide, multiple transition metal oxides (e.g. well-known NCM and NCA) and lithium iron phosphate. These oxides may contain a dopant, which is typically a metal element or several metal elements. The cathode active material may also be selected from chalcogen compounds, such as titanium disulfate, molybdenum disulfate, and metal sulfides. More preferred are lithium cobalt oxide (e.g., LiₓCoO₂ where 0.8≤x≤1), lithium nickel oxide (e.g., LiNiO₂), lithium manganese oxide (e.g., LiMn₂0₄ and LiMnO₂), lithium iron phosphate, lithium manganese-iron phosphate, lithium vanadium phosphate, and the like. Sulfur or lithium polysulfide may also be used in a Li—S cell.

For an anode-less lithium metal battery or sodium metal battery, the cathode active material needs to provide the required lithium ions or sodium ions and, thus, it should be lithiated (e.g. containing the element Li in LiMn₂0₄) or sodiated (containing Na in the chemical formula, such as in NaFePO₄).

The rechargeable lithium metal batteries can make use of non-lithiated compounds, such as TiS₂, MoS₂, MnO₂, CoO₂, V₃O₈, and V₂O₅, as the cathode active materials. The lithium vanadium oxide may be selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. In general, the inorganic material-based cathode materials may be selected from a metal carbide, metal nitride, metal boride, metal dichalcogenide, or a combination thereof. Preferably, the desired metal oxide or inorganic material is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form. These materials can be in the form of a simple mixture with sheets of a graphene material, but preferably in a nano particle or nano coating form that that is physically or chemically bonded to a surface of the graphene sheets.

Preferably, the cathode active material for a sodium metal battery contains a sodium intercalation compound or a potassium intercalation compound selected from NaFePO₄, KFCPO₄, Na₍₁₋ₓ₎KₓPO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y} (y/z=0.01 to 100), Se, Alluaudites, or a combination thereof, wherein x is from 0.1 to 1.0.

The organic material or polymeric material-based cathode materials may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino (triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, NaxC₆O₆ (x=1-3), Na₂ (C₆H₂O₄), Na₂C₈H₄O₄(Na terephthalate), Na₂C₆H₄O₄(Li trans trans-muconate), or a combination thereof.

The thioether polymer is selected from Poly[methanetetryl-tetra(thiomethylene)] (PMTTM), Poly(2,4-dithiopentanylenc) (PDTP), a polymer containing Poly(ethene-1,1,2,2-tetrathiol) (PETT) as a main-chain thioether polymers, a side-chain thioether polymer having a main-chain including conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio) benzene] (PTKPTB, or poly[3,4(ethylenedithio)thiophene] (PEDTT).

The organic material that can be used as a cathode active material in a lithium metal battery or sodium metal battery may include a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The following examples are used to illustrate some specific details about the best modes of practicing the instant invention and should not be construed as limiting the scope of the invention.

### Example 1: Preparation of Isolated Graphene Oxide Sheets and an Anode Layer of Oriented Graphene Sheets

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution including alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water. The suspension was dried and the resulting GO sheets were thermally reduced at 300° C. for 24 hours to obtain reduced graphene oxide (RGO) sheets.

A portion of the RGO sheets was dispersed in acetone form a dispersion. Part of the dispersion was compressed and consolidated into a porous layer of acetone-impregnated, compacted and highly oriented graphene sheets (liquid-impregnated laminar graphene structure) according to the process illustrated in FIG. 1(F). This was bonded to a current collector (Cu foil) with the graphene sheets aligned parallel to the Cu foil plane. This porous layer was then impregnated with lithium using a process similar to electrochemical plating. The process made use of this porous graphene layer as a working electrode and a piece of lithium metal as the counter-electrode with both electrodes immersed in a LiClO₄/propylene carbonate electrolyte.

### Example 2: Preparation of Single-Layer Graphene Sheets from Meso-Carbon Micro-Beads (MCMBs) and an Anode Layer of Oriented Graphene Sheets

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets were then made into porous anode layers each having oriented graphene sheets by following the presently invented process (as illustrated in FIG. 1(E)) and subsequent lithium metal melt impregnation.

### Example 3: Preparation of Pristine Graphene (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene supercapacitor having a higher electrical conductivity and lower equivalent series resistance. Pristine graphene sheets were produced by using the direct ultrasonication process (also called the liquid-phase exfoliation process).

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements. The pristine graphene sheets were then made into an anode layer as schematically illustrated in FIG. 5 by following the following steps:

(i) forming 10 porous laminar graphene structures according to FIG. 1(E) and impregnating the pores of these laminar graphene structures with a resin binder (polyethylene, PE) to form 10 laminar graphene/PE composite structures each having substantially aligned graphene sheets; (ii) using a compression molding press to stack the 10 laminar graphene/PE structures alternately 9 layers of graphene-free PE (as a sacrificial material) to form a laminate comprising alternating layers of graphene/PE composite structure and PE alone, wherein the PE layers have a layer thickness of 16 μm; (iii) attaching the laminate to a solid substrate layer (also a graphene/PE composite) with the constituent graphene sheets substantially perpendicular to the solid substrate, wherein one end each of the laminar graphene/PE structures touches the solid substrate and bonded thereto; and (iv) heat-treating the laminate to 900° C. to convert PE into some carbon (carbon yield 27%) to form a structure as schematically illustrated in FIG. 5, which contains porous walls of vertically oriented graphene sheets bonded by amorphous carbon. All the walls in an anode layer are bonded to and supported by a solid substrate comprising graphene sheets dispersed in a carbon matrix. Due to generally high strength of graphene sheets, this solid substrate is a member of good structural integrity.

### Example 4: Preparation of Graphene Oxide (GO) Suspension from Natural Graphite and of Subsequent GO-Based Anode Layers

Graphite oxide was prepared by oxidation of graphite flakes with an oxidizer liquid including sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions using ultrasonication. The suspension containing 15% of GO sheets was made into layers of graphene sheets according to the procedure described in FIG. 1(G). A graphene/carbon composite structure having substantially vertical walls, each containing oriented graphene sheets bonded by amorphous carbon, was prepared by following a procedure described in Example 3.

### Example 5: Preparation of Porous Graphene Fluoride (GF) Structures Comprising Vertically Aligned GF Sheets

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication lengths of time ensured better stability. Some of these GF sheets were dispersed in an organic solvent (NMP) to form several dispersion samples, which were then made into anode layers using the presently invented process (FIG. 1(F)).

### Example 6: Preparation of Graphene Structure Comprising Aligned Nitrogenataed Graphene Sheets

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene: urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenataed graphene sheets remain dispersible in water. The resulting suspensions were then made into an anode layer by following a procedure similar to that described in Example 2.

### Example 7: Evaluation of Various Lithium Metal and Sodium Metal Cells

In a conventional lithium or sodium cell, an electrode (e.g. cathode) is typically composed of 85% an electrode active material (e.g. MoS₂, V₂O₅, lithium transition metal oxides, etc.), 5% Super-P (acetylene black-based conductive additive), and 10% PTFE, which were mixed and coated on Al foil. The thickness of electrode is around 50-150 μm. A wide variety of cathode active materials were implemented, in combination with the anodes prepared in Examples 1-6, to produce lithium metal batteries and sodium metal batteries.

For each sample, both coin-size and pouch cells were assembled in a glove box. The charge storage capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

For each sample, several current density (representing charge/discharge rates) were imposed to determine the electrochemical responses, allowing for calculations of energy density and power density values required of the construction of a Ragone plot (power density vs. energy density).

Three sets of anode-less lithium metal cells were studied: (a) first cell containing the anode layer comprising vertically oriented graphene sheets prepared in Example 1 (but containing no lithium metal or sodium metal initially); (b) the second cell containing the anode layer comprising vertically oriented graphene sheets prepared in Example 3 (but containing no lithium metal or sodium metal initially); and (c) Cu foil as the anode current collector without an anode layer comprising vertically oriented graphene sheets. Corresponding lithium metal cells (containing lithium metal when the cell was made) were also prepared. The cathode active material used in all these cells was the well-known NCM-622 (lithium nickel cobalt manganese oxide). Charge-discharge properties of these cells indicate that the energy density and power density ranges of these cells are comparable. However, SEM examination of the cell samples, taken after 30 charge-discharge cycles, indicates that the samples containing a graphene anode layer have essentially all or most of the lithium ions returning from the cathode during charge being encased inside pores of the porous graphene structure, having no tendency to form lithium dendrites. In contrast, lithium metal tends to get re-plated on surfaces of Cu foil alone in a less uniform manner. Further surprisingly, the cells containing anode layer featuring oriented graphene sheets as an anode protecting layer exhibits very stable cycling behavior and a relatively long cycle life.

1. An anode or negative electrode for an alkali metal battery, said anode comprising:
(a) an anode current collector;
(b) an anode active material layer comprising (i) multiple vertically oriented graphene sheets that are substantially perpendicular to said anode current collector, wherein the graphene sheets are inclined relative to said current collector at an angle from 45 to 90 degrees and there are interstitial spaces or pores between graphene sheets; and (ii) an alkali metal, selected from lithium, sodium, potassium, or a combination thereof, wherein said alkali metal resides in the interstitial spaces or pores; and
(c) a first binder that bonds said anode active layer or said graphene sheets to said anode current collector.

2. The anode of claim 1, wherein said graphene sheets are produced from an exfoliated product of meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof.

3. The anode of claim 1, wherein said graphene sheets comprise single-layer or few-layer graphene sheets, wherein said few-layer graphene sheets have 2-10 layers of stacked graphene planes having an inter-plane spacing d₀₀₂ from 0.3354 nm to 2.0 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

4. The anode of claim 1, wherein said interstitial spaces have a pore size from 2 nm to 10 μm.

5. The anode of claim 1, wherein said interstitial spaces comprise interconnected pores to facilitate uptake and release of the alkali metal.

6. The anode of claim 1, wherein multiple graphene sheets are bonded together by a second binder or dispersed in said second binder, which is identical to or different than the first binder.

7. An alkali metal battery comprising a cathode, an anode of claim 1, and an electrolyte or separator-electrolyte assembly disposed between said cathode and said anode.

8. The alkali metal battery of claim 7, wherein said anode initially has no lithium, lithium alloy, sodium or sodium alloy as an anode active material residing in said interstitial spaces when the battery is made and prior to a charge or discharge operation of the battery.

9. The alkali metal battery of claim 7, wherein said anode initially has an amount of lithium, lithium alloy, sodium or sodium alloy as an anode active material residing in less than 20% by volume of the pores in the interstitial spaces.

10. The alkali metal battery of claim 7, further comprising a polymer that is disposed between said anode and said separator or electrolyte, wherein said polymer covers said anode active layer and preferably is partially impregnated into said interstitial spaces or coated on said graphene sheets, wherein said polymer is selected from (i) an ion-conducting polymer having an lithium ion or sodium ion conductivity no less than 10⁻⁶ S/cm; (ii) a high-elasticity polymer having a recoverable tensile strain no less than 10% (typically from 10% to 1,500%) when measured without an additive or reinforcement dispersed therein, or (iii) an ion-conducting polymer which is also a high-elasticity polymer.

11. The alkali metal battery of claim 10, wherein said high-elasticity polymer comprises a a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

12. The alkali metal battery of claim 10, wherein said high-elasticity polymer comprises a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

13. The alkali metal battery of claim 10, wherein said ion-conducting polymer is selected poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, poly(ether urethane), polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyacrylic acid (PAA), poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof, a sulfonated derivative thereof, or a combination thereof.

14. The alkali metal battery of claim 10, wherein said polymer further comprises a lithium ion-conducting additive or lithium salt dispersed therein and selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

15. The alkali metal battery of claim 10, wherein said high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

16. The alkali metal battery of claim 7, wherein said electrolyte comprises a liquid electrolyte, semi-liquid electrolyte, gel polymer electrolyte, solid polymer electrolyte, elastic solid electrolyte, inorganic solid electrolyte, a composite solid electrolyte, or a combination thereof, wherein said electrolyte is present in the anode, the separator, and/or the cathode.

17. The alkali metal battery of claim 16, wherein said electrolyte comprises an elastic solid electrolyte having a lithium ion or sodium ion conductivity no less than 10⁻⁶ S/cm and a recoverable elastic tensile strain no less than 10%.

18. A process for producing the anode of claim 1, said process comprising:
(a) preparing an anode current collector having two primary surfaces and providing and attaching a layer of vertically oriented graphene sheets to at least a primary surface, wherein said layer of vertically oriented graphene sheets comprise interstitial spaces or pores; and
(b) impregnating said interstitial spaces or pores with lithium metal or sodium metal to form said anode.

19. The process of claim 18, wherein said providing a layer of vertically oriented graphene sheets comprises (i) subjecting a carbon or graphite material to an expansion and exfoliation treatment selected from an oxidation, fluorination, bromination, chlorination, nitrogenation, intercalation, combined oxidation-intercalation, combined fluorination-intercalation, combined bromination-intercalation, combined chlorination-intercalation, combined nitrogenation-intercalation, mechanical shearing, ultrasonication, supercritical fluid exfoliation, electrochemical exfoliation, or a combination thereof to produce multiple graphene sheets; and (ii) compressing multiple graphene sheets using a wet compression or dry compression to align said graphene sheets substantially along one direction.

20. The process of claim 18, wherein said procedure of providing a layer of vertically oriented graphene sheets comprises:
A) preparing a graphene dispersion having multiple isolated graphene sheets dispersed in a liquid medium;
B) subjecting said graphene dispersion to a forced assembly procedure, forcing said multiple graphene sheets to assemble into liquid medium-impregnated laminar graphene structure, wherein said multiple graphene sheets are substantially aligned along a desired direction; and
C) removing said liquid medium to obtain a dry and porous laminar graphene structure having a physical density from 0.1 to 1.7 g/cm³ and a specific surface area from 50 to 3,300 m²/g.

21.-33. (canceled)
